(19) United States
(12) Patent Application Publication
(10) Pub. No.: US 2011/0138109 A1
(43) Pub. Date: Jun. 9, 2011

(54) METHOD FOR WEAR-LEVELING AND APPARATUS THEREOF

(76) Inventors: Chao-Yin Liu, Hsinchu City (TW); Ming-Cheng Chen, Changhua County (TW); Sheng-Hsuan Wang, Changhua County (TW)

(21) Appl. No.: 12/720,676

(22) Filed: Mar. 10, 2010

(30) Foreign Application Priority Data
Dec. 7, 2009 (TW) 098141687

(51) Int. Cl. G06F 12/00; G06F 12/02

(52) U.S. Cl. 711/103; 711/E12.001; 711/E12.008

(57) ABSTRACT

A method for Wear-Leveling includes: utilizing a comparison circuit to compare an average erase count with an erase count of a first data block; and utilizing a first free block as a replacement for storing data content of the first data block so as to make the first data block become a free block when the erase count of the first data block is smaller than the average erase count.

### BACKGROUND OF THE INVENTION

1. Field of the Invention

The present invention relates to a wear-leveling scheme, and more particularly, to a wear-leveling method and apparatus thereof.

2. Description of the Prior Art

In order to extend the life of a memory unit such as a flash memory unit, conventional methods are devoted to balancing the erase counts of all storage blocks within the memory unit. A problem, however, is that this prior art skill cannot achieve an optimal or better effect for balancing the erase counts of the storage blocks. Thus, for prolonging the life of the memory unit as far as possible, it is imperative to develop/provide a novel wear-leveling method having an improved or optimal performance, and an application apparatus thereof.

### SUMMARY OF THE INVENTION

It is therefore one of the objectives of the present invention to provide a novel wear-leveling method and a related apparatus applied to wear-leveling, to solve the problem mentioned above.

According to an embodiment of the present invention, a wear-leveling method is disclosed. The wear-leveling method comprises: utilizing a comparison circuit to compare an average erase count with an erase count of a first data block; and when the erase count of the first data block is smaller than the average erase count, utilizing a first free block as a replacement storage block for exchanging data content of the first data block, so as to make the first data block become a free block.

According to another embodiment of the present invention, a wear-leveling method is disclosed. The wear-leveling method comprises: utilizing a priority queue to store a plurality of free blocks; assigning a plurality of different priorities to the free blocks according to a plurality of corresponding erase counts of the free blocks; sorting the free blocks within the priority queue in order according to the assigned different priorities; and, during data writing, selecting a third free block according to the different priorities, so as to write data into the third free block.

According to an embodiment of the present invention, an apparatus for wear-leveling is disclosed. The apparatus comprises a storage unit, a comparison circuit, and a processing circuit. The storage unit is used for storing an average erase count. The comparison circuit is coupled to the storage unit and used for comparing the average erase count with an erase count of a first data block. The processing circuit is coupled to the comparison circuit and used for using a free block as a replacement storage block for exchanging data content of a data block. The erase count of the first data block is smaller than the average erase count, and the processing circuit is utilized for using a first free block as a replacement storage block to store data content of the first data block, so as to make the first data block become a free block.

According to the embodiment of the present invention, an apparatus for wear-leveling is disclosed. The apparatus comprises a priority queue and a processing circuit. The priority queue is used for storing a plurality of free blocks and sorting the free blocks within the priority queue according to different priorities which are respectively assigned to the free blocks according to a plurality of corresponding erase counts of the free blocks. The processing circuit is used for selecting a third free block according to the different priorities during data writing, so as to write data into the third free block.

Because the priority queue is utilized for sorting the free blocks to generate a sorting result used as a reference for wear-leveling, a better performance can be easily achieved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an apparatus according to a first embodiment of the present invention.

FIG. 2 is a diagram illustrating a flowchart of the apparatus shown in FIG. 1.

FIG. 3 is a diagram illustrating an apparatus according to a second embodiment of the present invention.

FIG. 4 is a flowchart illustrating the operation of the apparatus shown in FIG. 3.

### DETAILED DESCRIPTION

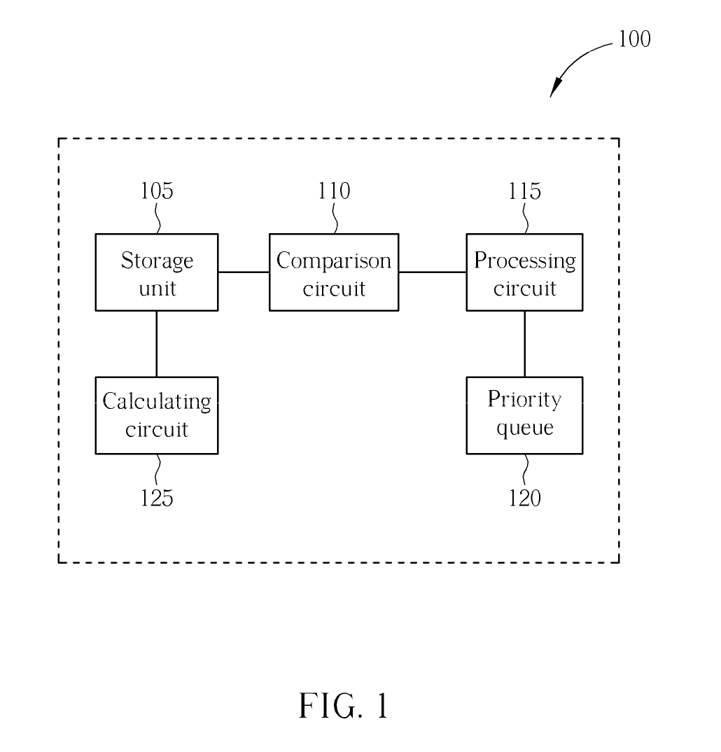

Please refer to FIG. 1. FIG. 1 is a block diagram of an apparatus 100 according to a first embodiment of the present invention. The apparatus 100 comprises a storage unit 105, a comparison circuit 110, a processing circuit 115, a priority queue 120, and a calculating circuit 125. The apparatus 100 executes a static wear-leveling algorithm. The static wear-leveling algorithm interchanges data of a free block with data of a data block every predetermined time interval or each time data accessing is executed a predetermined number of times, to achieve the purpose of equal erasing of storage blocks. The free block relates to a storage block that may be frequently used for data accessing, and the data block relates to a storage block that may not be frequently used for data accessing. Since the apparatus 100 can be applied to a flash memory product device, the life of such a flash memory product device will be extended. Specifically, a data block is a storage block that has been used for storing data at a specific time, and a free block is a storage block that has not been used for storing any data at the specific time. The apparatus 100 further includes a data block list for recording all data blocks in this system at the specific time. The storage unit 105 is used for storing an average erase count C_{avg} that is generated by the calculating circuit 125. The calculating circuit 125 averages a plurality of erase counts of a plurality of data blocks and a plurality of corresponding erase counts of a plurality of free blocks so as to generate the average erase count C_{avg}. Specifically, the calculating circuit 125 is arranged to average erase counts of all storage blocks (all data blocks and free blocks) within this system to derive the average erase count C_{avg}. However, this is not meant to be a limitation of the present invention. In another embodiment, the average erase count C_{avg} can also be a predetermined value that is defined by manufacturers or providers.

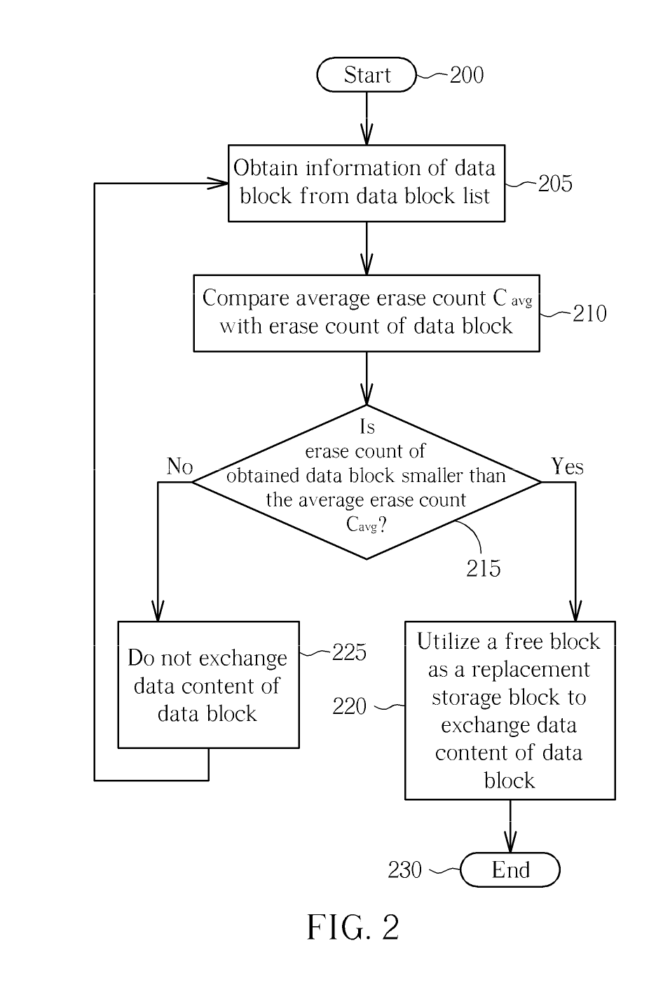

The following is a description about the flow of the static wear-leveling algorithm of the apparatus 100. Please refer to FIG. 2. FIG. 2 is a diagram illustrating a flowchart of the apparatus 100 as shown in FIG. 1. First, in Step 205, the apparatus 100 obtains information about a first data block from the data block list. In Step 210, the comparison circuit 110 coupled to the storage unit 105 is arranged to compare the average erase count C_{avg} with the erase count of the first data block and then output the comparison result to the processing circuit 115. The processing circuit 115 coupled to the comparison circuit 110 is arranged to decide whether to interchange data content of a data block with that of a free block according to the comparison result outputted by the comparison circuit 110, so as to interchange the data block with the free block. Particularly, in Step 215, the comparison circuit 110 determines whether the erase count of the first data block is smaller than the average erase count C_{avg} or not. When the comparison result indicates that the erase count of the first data block is smaller than the average erase count C_{avg}, the flow proceeds to Step 220. In Step 220, the processing circuit 115 utilizes a first free block as a replacement storage block to exchange the data content of the first data block such that the first data block becomes a free block; this interchanges the first data block with the first free block. The flow then proceeds to Step 230 (‘End’). When the comparison result indicates that the erase count of the first data block is not smaller than the average erase count C_{avg}, the flow proceeds to Step 225 instead of Step 220. In Step 225, the processing circuit 115 does not use a replacement storage block to store data content of the first data block.

The flow then returns to Step 205, and the apparatus 100 obtains information of a second data block from the data block list. In Step 210, the comparison circuit 110 compares the average erase count C_{avg} with an erase count of a second data block and outputs another comparison result to the processing circuit 115. Next, in Step 215, the processing circuit 115 decides whether to use a free block as a replacement to interchange data content of the second data block with that of a free block. Similarly, if the erase count of the second data block is not smaller than the average erase count C_{avg}, the processing circuit 115 will not interchange data content of the second data block with that of the free block. Next, the apparatus 100 obtains information of yet another data block such as a third data block from the data block list, and the comparison circuit 110 compares the erase count of the third data block with the average erase count C_{avg} and outputs another comparison result. The operations of obtaining yet another data block and comparing an erase count with the average erase count C_{avg} continue until the processing circuit 115 completes one data interchange between two storage blocks. The flow proceeds to Step 230 (‘End’) when the data interchange is completed.

Thus, in this embodiment, after the processing circuit 115 completes one data interchange between data content of two storage blocks, the operation of the static wear-leveling algorithm is also ended. In other words, during one execution of the static wear-leveling algorithm, it is not necessary for the comparison circuit 110 to respectively compare corresponding erase counts of all data blocks inside the data block list with the average erase count C_{avg}. Comparing the erase counts of all the data blocks with the average erase count C_{avg} is not intended to be a limitation of the present invention. Additionally, in another embodiment, the apparatus 100 can also terminate the operation of the static wear-leveling algorithm after the processing circuit 115 achieves data interchange a plurality of times. In other embodiments, the comparison circuit 110 can be defined to respectively compare the erase counts of all the data blocks inside the data block list with the average erase count C_{avg} during one execution of the static wear-leveling algorithm. The above-mentioned modifications all obey the spirit of the present invention.

As mentioned above, since data content of at least one data block having smaller erase count can be interchanged with that of a free block during one execution of the static wear-leveling algorithm, the apparatus 100 can achieve the purpose of wear-leveling of storage blocks by executing the static wear-leveling algorithm repeatedly. Please note that the above-mentioned data blocks having smaller erase counts are storage blocks that are not frequently read from and written to. Therefore, using the static wear-leveling algorithm to exchange data of the storage blocks (the data and free blocks) can equivalently interchange the data block with the free block, thereby balancing the erase counts of the storage blocks and extending the life of each storage block.

Further, the apparatus 100 uses a free block (e.g. the first free block) having a maximum erase count among all the free blocks to exchange data of the first data block with a free block (if the erase count of the first data block is smaller than the average erase count C_{avg}). In other words, the erase count of the first free block mentioned above is larger than the erase count of any free block such as a second free block. In order to achieve the storage blocks being arranged in order, in this embodiment the priority queue 120 is used to store all or a plurality of free blocks and to sort the free blocks according to different priorities of the free blocks, wherein the different priorities are respectively assigned to the free blocks according to respective erase counts of the free blocks. Lower priority is assigned to a free block having a larger erase count, and higher priority is assigned to a free block having a smaller erase count. The free block having the highest priority assigned thereto is positioned at the queue header of the priority queue 120, and the free block having the lowest priority assigned thereto, e.g. the first free block, is positioned at the queue tail of the priority queue 120. In other words, the first free block mentioned above is buffered in the priority queue 120 and has a corresponding priority which is lower than the priority of the second free block. In accordance with the operation of the static wear-leveling algorithm, when the processing circuit 115 is about to select a free block from all free blocks each time exchange of a data block occurs, the processing circuit 115 is arranged to select a free block having the lowest priority in the priority queue 120 to interchange data content of the data block. That is, the processing circuit 115 selects the first free block corresponding to the queue tail of the priority queue 120. However, this is not meant to be a limitation of the present invention. In another embodiment, instead of choosing the free block having the lowest priority, the processing circuit 115 is designed to select a free block having a lower priority in the priority queue 120 to exchange the data block.

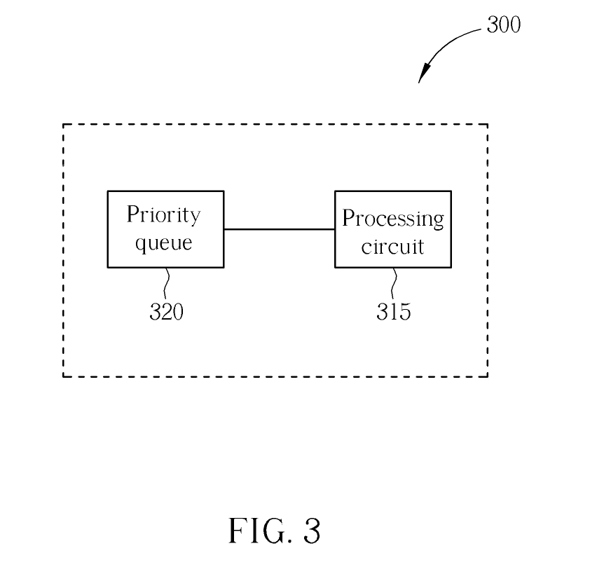

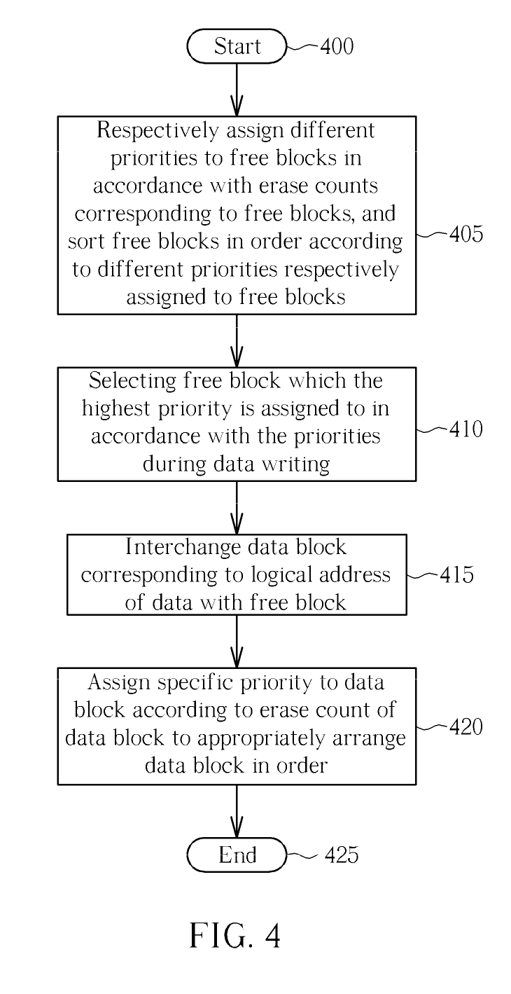

Please refer to FIG. 3 in conjunction with FIG. 4. FIG. 3 is a diagram illustrating an apparatus 300 according to a second embodiment of the present invention. FIG. 4 is a flowchart illustrating the operation of the apparatus 300 as shown in FIG. 3. The apparatus 300 comprises a priority queue 320 and a processing circuit 315, and the apparatus 300 is utilized for performing the operation of a dynamic wear-leveling algorithm. When a computing host is executing data writing, the apparatus 300 writes data into a free block having a smaller erase count so as to interchange a data block corresponding to a logical block address of the data with a free block. This operation can make the data block become a free block. Since the apparatus 300 writes data into a free block having a smaller erase count when the computing host is executing data writing each time, all the free blocks inside this system are equally or uniformly used. Therefore, the apparatus 300 can easily achieve the purpose of wear-leveling of storage blocks. Specifically, the priority queue 320 is utilized for buffering a plurality of or all free blocks. In Step 405, different priorities are respectively assigned to the free blocks in accordance with a plurality of erase counts corresponding to the free blocks, and the priority queue 120 is arranged to sort the free blocks in an order according to the different priorities respectively assigned to the free blocks. The higher priority is assigned to a free block having a smaller erase count, and the lower priority is assigned to a free block having a larger erase count. The priority queue 320 is arranged to put in a free block corresponding to the assigned highest priority at the queue header, and to put in a free block corresponding to the assigned lowest priority at the queue tail.

In Step 410, the processing circuit 315 is utilized for selecting a third free block having the highest priority assigned thereto in accordance with the priorities so as to write data into the third free block when the computing host is executing data writing. Afterward in Step 415 the processing circuit 315 interchanges a third data block corresponding to a logical address of the data with the third free block, and then makes the third data block become a free block. In Step 420, a specific priority is assigned to the third data block according to an erase count of the third data block, and the priority queue 320 is designed to appropriately arrange the third data block in order according to the priority assigned to the third data block. By using the priority queue 320, the third data block which has become a free block at this point can be placed in the priority queue 120 and appropriately arranged in order. Through utilizing a free block having the highest priority to execute data writing by the processing circuit 315, the performance of the dynamic wear-leveling algorithm performed by the apparatus 300 can be significantly improved.

Furthermore, in still another embodiment of the present invention, the above operations of the static wear-leveling algorithm and the dynamic wear-leveling algorithm can be integrated in the same apparatus, to achieve better performance of wear-leveling. In summary, both the operations of the static wear-leveling algorithm and the dynamic wear-leveling algorithm rely on a priority queue to sort all or a plurality of free blocks within a system. The arrangement of sorting is to arrange the free blocks in order according to erase counts of the free blocks. Therefore, any modification concerning sorting free blocks according to priorities also obeys the spirit of the present invention.

Those skilled in the art will readily observe that numerous modifications and alterations of the device and method may be made while retaining the teachings of the invention.

What is claimed is:

1. A wear-leveling method, comprising:
utilizing a comparison circuit to compare an average erase count with an erase count of a first data block; and
when the erase count of the first data block is smaller than the average erase count, utilizing a first free block as a replacement storage block for exchanging data content of the first data block, so as to make the first data block become a free block.

2. The wear-leveling method of claim 1, further comprising:
using a priority queue to store a plurality of free blocks, wherein the first free block is stored in the priority queue;
assigning a plurality of different priorities to the free blocks according to a plurality of corresponding erase counts of the free blocks; and
sorting the free blocks inside the priority queue in an order according to the different priorities respectively assigned to the free blocks.

3. The wear-leveling method of claim 1, wherein an erase count of the first free block is larger than an erase count of a second free block, and a priority of the first free block is lower than a priority of the second free block.

4. The wear-leveling method of claim 3, wherein the erase count of the first free block is a maximum erase count among erase counts of a plurality of free blocks, and the priority of the first free block is a lowest priority compared to priorities of the free blocks.

5. The wear-leveling method of claim 1, further comprising:
averaging erase counts of a plurality of data blocks and a plurality of free blocks, to derive the average erase count.

6. The wear-leveling method of claim 1, wherein the step of comparing the average erase count with the erase count of the first data block is performed every predetermined time interval or is performed each time data accessing is executed a predetermined number of times.

7. The wear-leveling method of claim 1, further comprising:
when the erase count of the first data block is not smaller than the average erase count, comparing the average erase count with an erase count of a second data block, to determine whether to use a free block as a replacement for interchanging data content of the second data block;
wherein the step of comparing the average erase count with the erase count of the second data block is performed until data content interchange is completed one time.

8. A wear-leveling method, comprising:
utilizing a priority queue to store a plurality of free blocks;
assigning a plurality of different priorities to the free blocks according to a plurality of corresponding erase counts of the free blocks;
sorting the free blocks within the priority queue in an order according to the assigned different priorities; and
during data writing, selecting a third free block according to the different priorities, so as to write data into the third free block.

9. The wear-leveling method of claim 8, wherein the step of selecting the third free block according to the different priorities comprises:
selecting the third free block having highest priority; and
the wear-leveling method further comprises:
making a replacement storage block replace a third data block corresponding to a logical address of the data so as to make the third data block become a free block; and
assigning the third data block a priority according to an erase count of the third data block, and arranging the third data block within the priority queue in order.

10. An apparatus for wear-leveling, comprising:
a storage unit, for storing an average erase count;
a comparison circuit, coupled to the storage unit, for comparing the average erase count with an erase count of a first data block; and
a processing circuit, coupled to the comparison circuit, for using a free block as a replacement storage block for exchanging data content of a data block;
wherein the erase count of the first data block is smaller than the average erase count, and the processing circuit is utilized for using a first free block as a replacement storage block to store data content of the first data block, so as to make the first data block become a free block.

11. The apparatus of claim 10, further comprising:
a priority queue, for storing a plurality of free blocks and sorting the free blocks within the priority queue in an order according to different priorities respectively assigned to the free blocks;
wherein the different priorities are respectively assigned to a plurality of free blocks according to a plurality of corresponding erase counts of the free blocks.

12. The apparatus of claim 10, wherein an erase count of the first free block is larger than an erase count of a second free block, and a priority of the first free block is lower than a priority of the second free block.

13. The apparatus of claim 12, wherein the erase count of the first free block is a maximum erase count among erase counts of the free blocks, and the priority of the first free block is a lowest priority among the priorities of the free blocks.

14. The apparatus of claim 10, further comprising:
a calculating circuit, for averaging a plurality of erase counts of a plurality of data blocks and a plurality of free blocks to derive the average erase count, and storing the average erase count into the storage unit.

15. The apparatus of claim 10, wherein the comparison circuit is utilized for comparing the average erase count with the erase count of the first data block every predetermined time interval or each time data accessing is executed a predetermined number of times.

16. The apparatus of claim 10, wherein when the erase count of the first data block is not smaller than the average erase count, the comparison circuit compares the average erase count with an erase count of a second data block, to determine whether to use a free block as a replacement storage block for exchanging data content of the second data block; and the comparison circuit compares the average erase count with the erase count of the second data block until data content replacement is completed one time.

17. An apparatus for wear-leveling, comprising:
a priority queue, for storing a plurality of free blocks and sorting the free blocks within the priority queue in order according to different priorities which are respectively assigned to the free blocks according to a plurality of corresponding erase counts of the free blocks; and
a processing circuit, for selecting a third free block according to the different priorities during data writing, so as to write data into the third free block.

18. The apparatus of claim 17, wherein the processing circuit selects the third free block having highest priority, exchanges a third data block corresponding to a logical address of the data so as to make the third data block become a free block, assigns the third data block a priority according to an erase count of the third data block, and arranges the third data block within the priority queue in order.
